(19) United States
(12) Patent Application Publication
(10) Pub. No.: US 2012/0185166 A1
(43) Pub. Date: Jul. 19, 2012

(54) Portable Communication Device with Inert Navigator

(76) Inventors: Kuo-Ching CHIANG, New Taipei City (TW); Yung-Chi Liang, New Taipei City (TW)

(21) Appl. No.: 13/351,212

(22) Filed: Jan. 16, 2012

(30) Foreign Application Priority Data
Jan. 17, 2011 (TW) 100101695
Apr. 29, 2011 (TW) 100115222

(51) Int. Cl. G01C 21/16

(52) U.S. Cl. 701/445; 701/409

(57) ABSTRACT

A portable device comprises a processing unit embedded in the portable device; a transmission module coupled to the processing unit for wireless communication; an inert navigator module coupled to the processing unit for measure geography information, wherein the inert navigator module includes gyro, accelerator or the combination thereof; an electronic map module stored in the portable device or a remote server to provide geography map; a display and an input unit coupled to the processing unit to display the geography map, wherein the geography information of the portable device measured by the inert navigator module is displayed on the geography map to indicate the location of the portable device. A calibrator is coupled to the portable device to calibrate the inert navigator module.

### CROSS REFERENCE TO RELATED APPLICATIONS

This application claims the benefit of TAIWAN patent application No. 100101695 and 100115222, respectively filed on Jan. 17, 2011 and Apr. 29, 2011.

### FIELD OF THE INVENTION

The present invention relates generally to a portable terminal and more particularly to a portable terminal with inert navigator.

### BACKGROUND OF RELATED ART

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. The cellular manufactures have to release new models with different appearances, function and styles more frequently so as to attract the attention of the buyer and occupy a favorable marketing share.

Furthermore, the GPS is failure in the base room, tunnel, or underground. It cannot tell the high pass way or ground road. It also consumes battery power. The error of traditional inert navigator will be accumulated thereby losing the precision for location positioning.

### SUMMARY

The object of the present invention is to provide a multi-function portable communication device.

A portable device comprises a processing unit embedded in the portable device; a transmission module coupled to the processing unit for wireless communication; an inert navigator module coupled to the processing unit for measure geography information, wherein the inert navigator module includes gyro, accelerator or the combination thereof; an electronic map module stored in the portable device or a remote server to provide geography map; a display and an input unit coupled to the processing unit to display the geography map, wherein the geography information of the portable device measured by the inert navigator module is displayed on the geography map to indicate the location of the portable device. A calibrator is coupled to the portable device to calibrate the inert navigator module. The calibrator includes a GPS. The geography information is displayed with longitude and latitude.

A portable device comprises a processing unit embedded in the portable device; a transmission module coupled to the processing unit for wireless communication; a magnetic compact coupled to the processing unit for measure geography information; an electronic map module stored in the portable device or a remote server to provide geography map; a display and an input unit coupled to the processing unit to display the geography map, wherein the geography information of the portable device measured by the magnetic compact is displayed on the geography map to indicate the location of the portable device. A calibrator is coupled to the portable device to calibrate the inert navigator module. The calibrator includes a GPS.

### BRIEF DESCRIPTION OF THE DRAWINGS

FIG. 1 shows a diagram of a portable terminal according to the present invention.

FIG. 2 shows a diagram of a portable terminal according to the present invention.

FIGS. 3 and 4 show a diagram of a portable terminal according to the present invention.

FIG. 5 shows a diagram according to the present invention.

### DETAILED DESCRIPTION

The present invention relates to a portable communication device with inert navigator and calculator. The portable device according to the present invention includes but not limited to cellular, PDA (personal digital assistant), smart phone, note book, tablet and digital camera and the equivalent thereof.

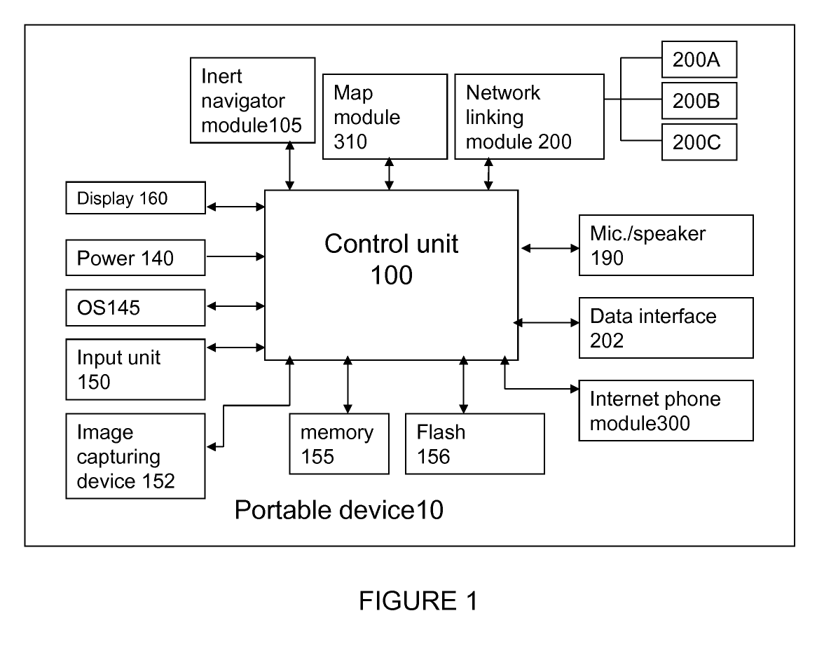

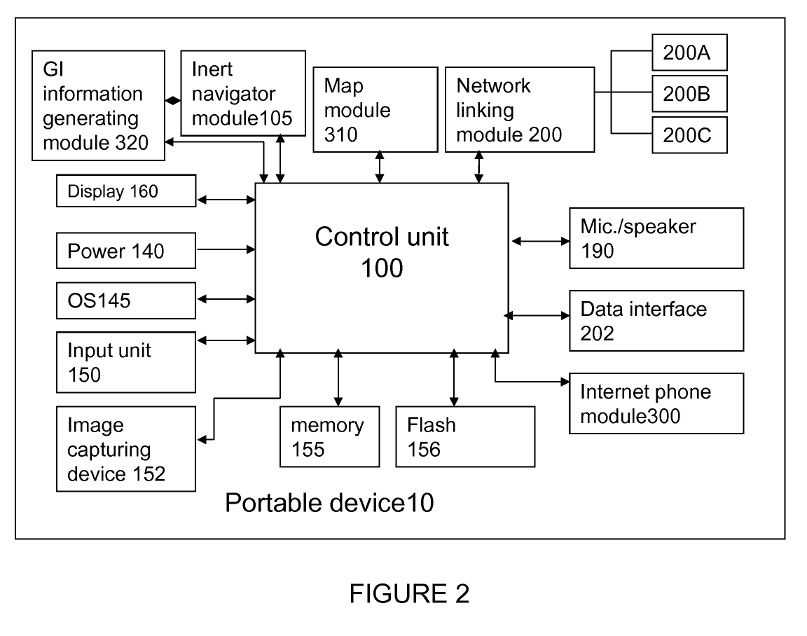

FIG. 1 and FIG. 2 show a block diagram of a portable communication device having processor 100, an inert navigator module 105 coupled to the processor 100. The inert navigator module 105 is gyro, G-sensor or accelerator. The type of the inert navigator module 105 includes mechanical type, MEMS or fiber type navigator. The inert navigator module 105 may define the location without reception of the satellite signals, therefore, the present invention may navigate even in the base room, underground or tunnel. The inert navigator module 105 includes geography interpreter or look-up table to interpret the geography information detected by the inert navigator module 105. The geography information interpreted by the inert navigator module 105 can be displayed on the display of the device. The system 100 includes input unit 150, display 160, OS 145, an image capturing device 152, and power source 140. The OS 145 maybe any type of the mobile phone OS, for instance, android, MS, Apple OS. An electronic map module 310 is stored in the memory or a remote server. The inert navigator module 105 is processed with the electronic map module 310 and may indentify the geography information (such as longitude and latitude) or locating the location of the current portable communication device location on the map.

As know in the art, the RF signal transmission module includes antenna. This antenna 105 is connected to a transceiver, which is used to receive and transmit signal. AS know, the RF module further includes MODEN, CODEC, DSP and A/D converter as well. Due to the RF module is not the feature of the present invention, therefore, the detailed description is omitted. The present invention includes a central control IC, an input unit, a build-in display, OS, power and memory including a ROM program memory, a RAM memory. All of the components are coupled to the Control IC. Nonvolatile FLASH memory is coupled to the control IC. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

A data exchange interface 200 is provided and coupled to the control IC 100. The data exchange interface 200 is capable of coupling to the I/O port of a computer system, directly or indirectly. The data exchange interface 200 provides the interface for exchanging the information between the portable device and the computer system. At current, the conventional cell-phone is incapable communicated with the computer system by its built-in unit. The data exchange interface 200 is preferred a USB (universal serial bus) interface or Fire Wire interface or the IEEE 1394. The USB or the Fire Wire 200 is provided and coupled to the control IC 100. Through the USB interface or the Fire Wire 200, the user may transmit the data such as E-mail, MP3 file, image file (taken by the image capturing unit 152) or downloaded data to the computer. Alternatively, the portable device 10 may update information such as OS, program or the like from the computer system

The data exchange interface 200 may includes wireless internet network exchange interface 200A, wireless metropolis network exchange interface 200B, or mobile phone network 200C, such as 3G, 4G or higher standard. The data exchange interface 200 may download or update the electronic map or weather, traffic, gas station information. A part of the USB or the Fire Wire interface 200 maybe extended outside the housing of the flash drive-like cellular. The inner end of the interface 200 fastened into the inside of the housing. The aforementioned USB interface 200 could be A-type USB interface with a flat and wide shape, or B-type USB interface with a rectangular shape or a Mini-type USB interface with a flat and narrow shape. The definition of USB type may refer to US Patent Application No. 20040038592, entitled “USB flash drive”. The flash memory could be replaced by other NVM (non-volatile memory) such as NROM (nitride-ROM), SONOS or MRAM, FRAM. The present HPC may function as memory drive. The memory drive refers to a commercial memory device with USB interface such as flash drive. The flash memory 156 can be coupled to the USB or the Fire Wire ports of personal computer, digital camera, etc. by means of the Fire Wire or USB interface 200 which is commercially available products. For the digital camera user, the capacity of the camera's memory card is small. The user has to change the memory card, frequently. One aspect of the present invention is that the digital camera or digital video camera may couple to the flash drive like cellular, thereby transferring the data or the image file to the flash memory 156 of the portable device through the USB interface 200. Further, the present invention also includes a wireless transmission unit for short distance transmission between the cellular and a computer. A VoIP phone module 300 is coupled to the processor 100 for allow the user to call internetwork phone through the interface 200, for instance, Wi-Fi or WiMAX (Worldwide Interoperability for Microwave Access).

Currently, the mass traffic system, vehicle or transporter employs GPS as the location pointing, however, the monitor center may only know the location on the map, nothing else, the present invention provide a method to monitor the vehicle which includes INS module 105 is set in the vehicle to fetch the geography information (such as longitude and latitude) and the information is merged within the image hatched by the image captured set inside or outside of the vehicle. The transmitter may transmit the video image with the geography information (such as longitude and latitude) to the monitor center, therefore, the monitor center may receive the video with longitude and latitude to judge where the event occurred. The wireless transmitter includes WiFi, WiMax, 3G, 3,5G or 4G. The image capturing device includes digital still camera or digital video camera.

Further, a vibration threshold maybe set in the controller, when the vibration of the gyro is over the threshold, or continuously vibration to a time interval, or the gyro detect the vehicle is moved to a distance when the security system with the gyro is on duty. The security system coupled to the control IC issues alarm signal which refers to illegal event, such as steal, impact, intrude. The transmitter coupled to the control IC may transmit the captured image to the monitor center. The object may be vehicle, cellular, tablet. Therefore, the system may monitor the object with longitude and latitude information.

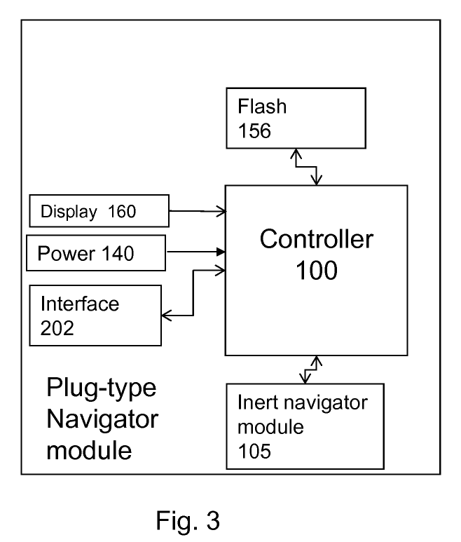

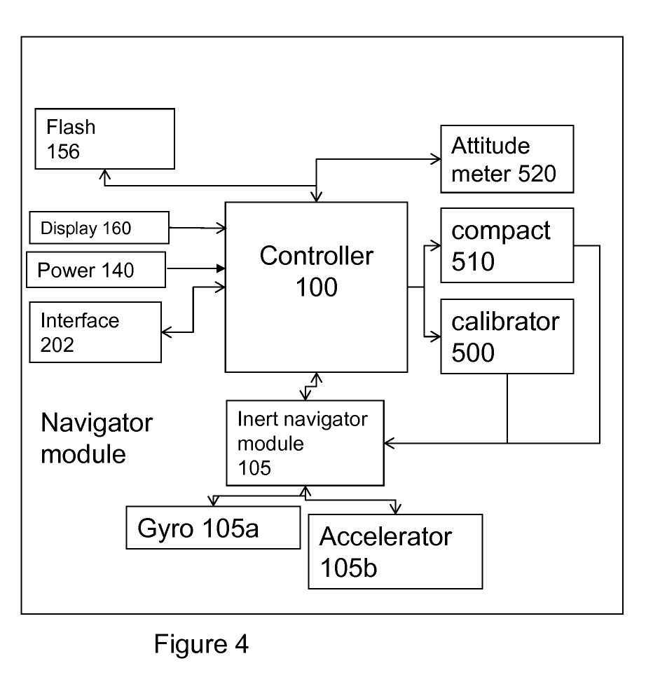

FIG. 3 and FIG. 4 show anther embodiments of the present invention, most of the elements are similar with above example. The embodiment further includes calibrator 500 coupled to the inert navigator module 105 to calibrate the accumulative errors of the inert navigator module 105. The inert navigator module 105 could be gyro 105a or accelerator 105b or the combination. The inert navigator module 105 maybe one axis, dual axis or triple axis, The accelerator 105b maybe one axis, dual axis or triple axis. The errors of the inert navigator module 105 or a magnetic compact 510 maybe accumulated, the present invention includes calibrator 500 coupled to the inert navigator module 105 or a magnetic compact 510 to correct the errors. The gyro 105a or accelerator 105b may be employed to fetch the geography and motion information such as direction, calibrator 500 may correct the error of the gyro 105a by fetching the satellite information. In one case, when the mobile device is switched on, the calibrator 500 is responsive the signal to calibrate or correct the initial conditions of the gyro 105a by receiving the satellite information with geography data to calibrate the gyro 105a. The device maybe set to calibrate the gyro 105a by time. The calibrator 500 maybe GPS, when the gyro or the magnetic compact is calibrated, the GPS is off to save the power due to the inert navigator module 105 or the magnetic compact 510 maybe operated without electrical power. Further, the current arrangement may allow the mobile device be operation without the reception of the satellite signals and omit or reduce the kalman filters to save the resources. The attitude meter 520 is coupled to the control IC to distinguish whether the vehicle is on the ground or on the overpass way, the traditional GPS cannot tell the difference between both situations, which may cause the miss navigating.

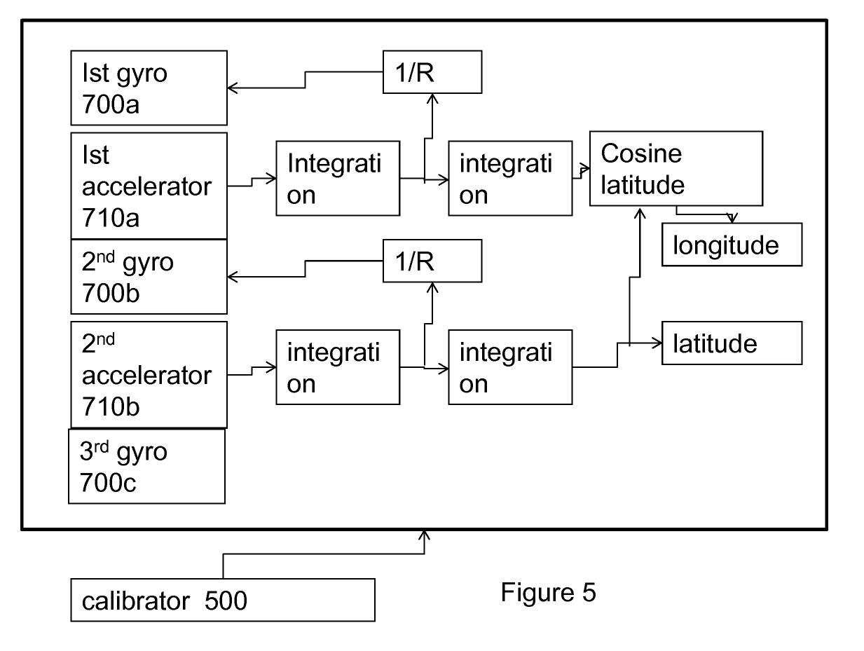

FIG. 5 shows another example, the inert navigator module 105 includes the first, the second and the third gyros 700a, 700b and 700c; and the first accelerator, the second accelerator 710a, 710b. The integration of the data measured by the first accelerator, the second accelerator 710a, 710b are speeds of the respective two directions. Then, the distance maybe measured by integration of the speeds. The distance, the direction, and vector may be obtained by the above method. The geography information (such as longitude and latitude) can be obtained with further processes. It can be obtained by three accelerators. Each one accelerator can measure one-axis acceleration, and the direction, speed may be obtained by integrations.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A portable device comprising:
a processing unit embedded in the portable device;
a transmission module coupled to the processing unit for wireless communication;
an inert navigator module coupled to said processing unit for measure geography information, wherein said inert navigator module includes gyro, accelerator or the combination thereof;
an electronic map module stored in said portable device or a remote server to provide geography map;
a display and an input unit coupled to the processing unit to display said geography map, wherein said geography information of said portable device measured by said inert navigator module is displayed on said geography map to indicate the location of said portable device.

2. The portable device of claim 1, further comprising a calibrator coupled to said portable device to calibrate said inert navigator module.

3. The portable device of claim 2, wherein said calibrator includes a GPS.

4. The portable device of claim 3, wherein said geography information is displayed with longitude and latitude.

5. The portable device of claim 1, wherein said portable device includes image capture device.

6. The portable device of claim 5, further comprising a calibrator coupled to said portable device to calibrate said inert navigator module.

7. The portable device of claim 6, wherein said calibrator includes a GPS.

8. The portable device of claim 1, wherein said portable device includes magnetic compact.

9. The portable device of claim 8, further comprising a calibrator coupled to said portable device to calibrate said inert navigator module.

10. The portable device of claim 9, wherein said calibrator includes a GPS.

11. A portable device comprising:
a processing unit embedded in the portable device;
a transmission module coupled to the processing unit for wireless communication;
a magnetic compact coupled to said processing unit for measure geography information;
an electronic map module stored in said portable device or a remote server to provide geography map;
a display and an input unit coupled to the processing unit to display said geography map, wherein said geography information of said portable device measured by said magnetic compact is displayed on said geography map to indicate the location of said portable device.

12. The portable device of claim 11, further comprising a calibrator coupled to said portable device to calibrate said inert navigator module.

13. The portable device of claim 12, wherein said calibrator includes a GPS.

14. The portable device of claim 11, wherein said portable device includes image capture device.

15. The portable device of claim 11, further comprising a calibrator coupled to said portable device to calibrate said inert navigator module.

16. The portable device of claim 15, wherein said calibrator includes a GPS.
